(19) United States
(12) Patent Application Publication
(10) Pub. No.: US 2008/0250319 A1
(43) Pub. Date: Oct. 9, 2008

(54) SYSTEM AND METHOD FOR DETERMINING MEDIA PLAYBACK BEHAVIOUR IN A MEDIA APPLICATION FOR A PORTABLE MEDIA DEVICE

(75) Inventors: Matthew Lee, Belleville (CA); Andrew James Turcotte, Stittsville (CA); Samer Fahmy, Waterloo (CA); Andrew Douglas Bocking, Waterloo (CA); Michael Thomas Hardy, Waterloo (CA); Alen Mujkic, Mississauga (CA)

Correspondence Address: OGILVY RENAULT LLP, 1981 MCGILL COLLEGE AVENUE, SUITE 1600, MONTREAL, QC, H3A2Y3, CA

(73) Assignee: RESEARCH IN MOTION LIMITED, Waterloo (CA)

(21) Appl. No.: 11/696,769

(22) Filed: Apr. 5, 2007

(51) Int. Cl. G06F 3/00

(52) U.S. Cl. 715/716

(57) ABSTRACT

A system and method is provided for determining playback behavior in a media application for a wireless communications device. The wireless communication device has a memory with media files stored therein. The method comprises the steps of: determining playback attributes associated with a media file; determining if a user triggered event occurs during the media file playback; determining if the media file playback ends due to the playback reaching the end of the media file; selecting a function to perform based on playback attributes of the file being played and based on whether the playback ends or the user triggered event occurs, wherein the selected function is based upon the determined attributes associated with the media file; and performing the selected function.

### TECHNICAL FIELD

The present disclosure relates generally to portable devices, and more particularly to a system and method for determining media playback behavior in a media application for a portable media device.

### BACKGROUND

Users of media applications on personal computers and wireless devices are accustomed to using playlists organized by the media player applications to organize collections of music files that they wish to listen to. Users must perform numerous functions within the media application, many of which operate on those playlists. However, users also use the same media player applications to listen to and view other types of files. User expectations vary according to the type of file the user is using with the media player application. However, typical media player applications handle most media files in the same way.

Portable devices have a fairly limited amount of screen space and battery power. Therefore, if media applications on portable devices are inefficient because the media applications: (a) perform functions in a way that the user does not wish, (b) use valuable screen space to show the user items he does not need to see, or (c) require the user to perform extra steps that are not necessary to achieve a desired task, the experience of using the portable device is detracted from. This wastes the user's time and also uses unnecessary computing resources on wireless devices such as processing and battery power.

Accordingly, it would be desirable to have a system and method for determining media playback behavior in a media application for a portable media device that serves to provide a more user friendly interface for users of media applications, such that media on the portable device is handled in a way that is closer to what the typical user expects.

### DESCRIPTION OF THE DRAWINGS

Reference will now be made to the drawings, which show by way of example, embodiments of the present disclosure, and in which:

FIG. 1 shows in block diagram form a wireless device suitable for running a media application in accordance with an embodiment;

FIG. 2 shows in block diagram form a communication system suitable for providing the operating environment of the wireless device of FIG. 1 in accordance with an embodiment;

FIG. 3 shows in block diagram form the contents of a memory of the wireless device of FIG. 1;

FIG. 4 is a front view illustrating the wireless device of FIG. 1;

FIG. 5 shows a block diagram of an example computer system that hosts a media management application for use with the wireless device of FIG. 1;

FIGS. 6a and 6b are diagrams illustrating screen images of a media player application;

FIGS. 7a and 7b are diagrams illustrating screen images of a media player application;

FIGS. 8a and 8b are diagrams illustrating screen images of a media player application;

FIG. 9 is a diagram illustrating a screen image of a media player application;

FIG. 10 is a flowchart illustrating a method of determining playback behavior in a media application; and

FIG. 11 is a flowchart illustrating another method of determining playback behavior in a media application.

It will be noted that throughout the appended drawings, like features are identified by like reference numerals.

### DETAILED DESCRIPTION

One aspect of the present application provides a method for determining playback behavior in a media application for a wireless communications device having a memory with media files stored therein. The method comprises the steps of determining playback attributes associated with a media file; determining if a user triggered event occurs during the media file playback; determining if the media file playback ends due to the playback reaching the end of the media file; selecting a function to perform based on playback attributes of the file being played and based on whether the playback ends or the user triggered event occurs, wherein the selected function is based upon the determined attributes associated with the media file; and performing the selected function.

Another aspect of the present application provides a wireless device for determining media file playback behavior in a media application. The wireless device comprises a microprocessor for controlling the operation of the wireless device; a first input device coupled to the microprocessor for accepting an input from a user of the wireless device; a display device coupled to the microprocessor for communicating an output to the user; a communications subsystem coupled to the microprocessor for communicating with a communications network; and a memory coupled to the microprocessor. The wireless device includes a media application module resident in the memory for execution by the microprocessor. The memory has media files stored therein. The media application module is configured to: determine media playback attributes associated with a media file; determine if a user triggered event occurs during the media file playback; determine if the media file playback ends due to the playback reaching the end of the media file; select a function to perform based on the attributes of the media file being played and based on whether the playback ends or the user triggered event occurs, wherein the selected function is based on the determined attributes associated with the media file; and perform the selected function.

Yet another aspect of the present application provides a computer program product having a computer readable medium tangibly embodying code for determining playback behavior in a media application for a wireless communications device having a memory with media files stored therein. The computer program product includes code for determining attributes associated with a media file; code for determining if the media file playback ends due to the playback reaching the end of the media file; code for determining if a user triggered event occurs during the media file playback; code for selecting a function to perform based on the type of media file being played and based on whether the playback ends or the user triggered event occurs, wherein the selected function is based on the determined attributes associated with the media file; and code for performing the selected function.

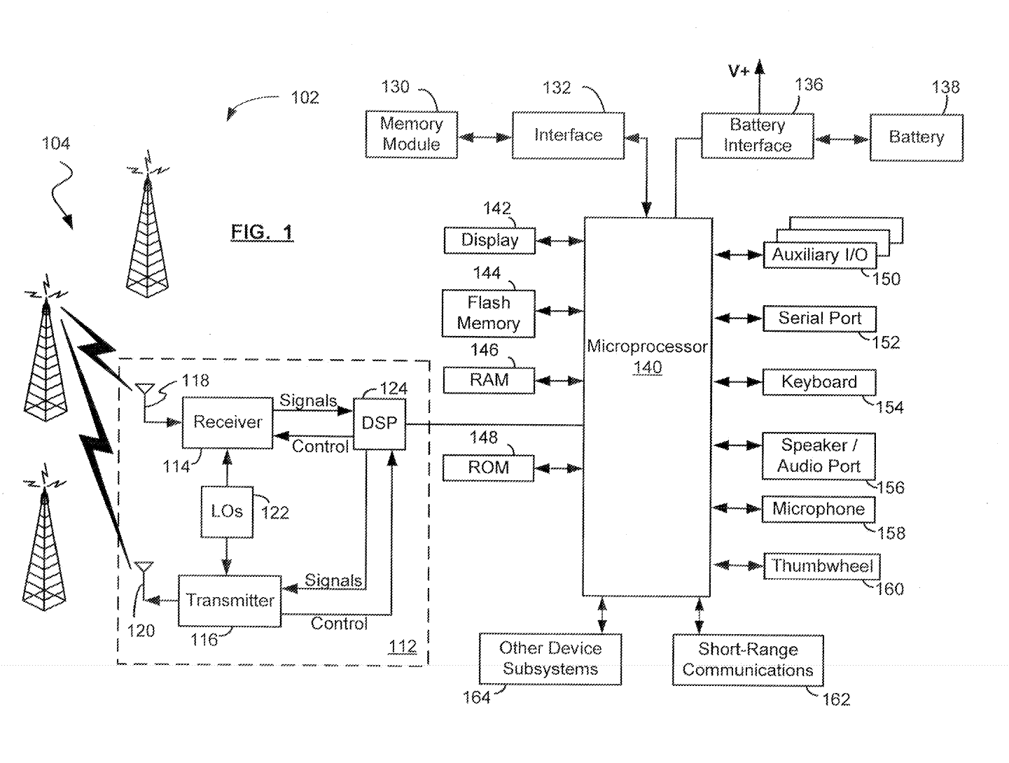

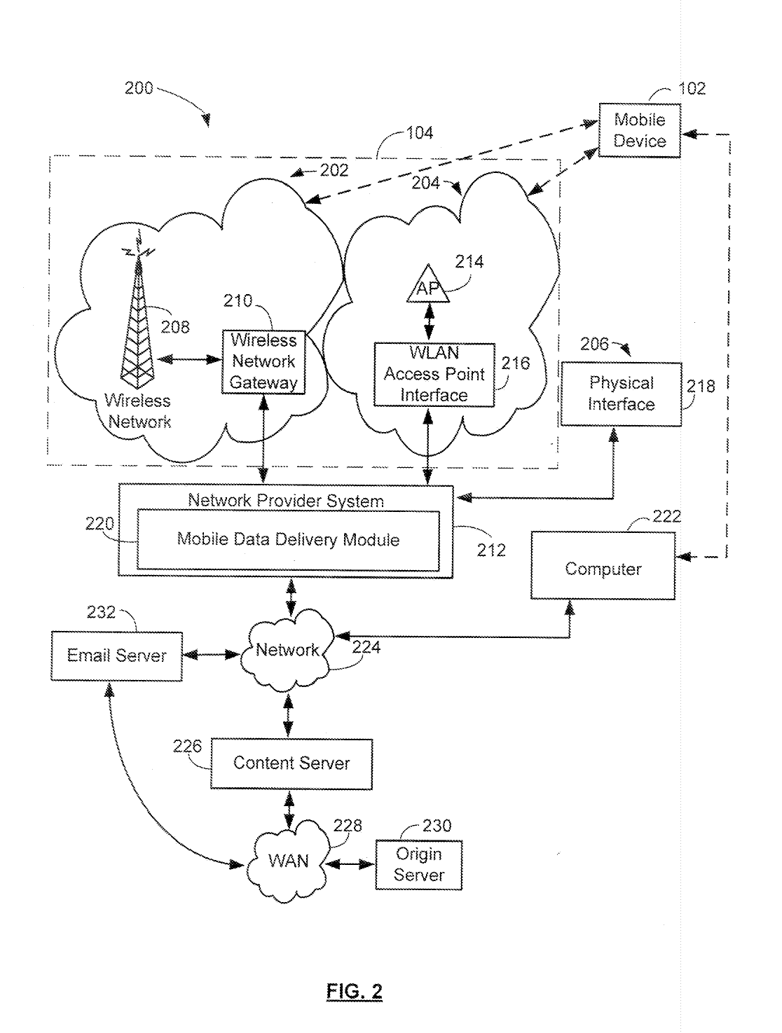

Reference is first made to FIG. 1, which shows a block diagram illustrating a portable wireless device 102 suitable for running a media player application in accordance with one embodiment of the present disclosure. The wireless device 102 communicates through a wireless communication network 104. The wireless network 104 includes antenna, base stations, and supporting radio equipment as for supporting wireless communications between the wireless device 102 and other devices connected to wireless network 104. The wireless network 104 may be coupled to a wireless network gateway and to a wide area network, shown in FIG. 2.

In one embodiment, the wireless device 102 is a two-way communication device having at least voice and data communication capabilities, including the capability to communicate with other computer systems. In one embodiment, the wireless device 102 is a handheld device. Depending on the functionality provided by the wireless device 102, it may be referred to as a data messaging device, a two-way pager, a cellular telephone with data messaging capabilities, a wireless Internet appliance, a data communication device (with or without telephony capabilities), or a portable media or music player. The wireless device 102 may communicate with any one of a plurality of fixed transceiver stations within its geographic coverage area.

The wireless device 102 may incorporate a communication subsystem 112, which includes a receiver 114, a transmitter 116, and associated components, such as one or more antenna elements 118 and 120, local oscillators (LOs) 122, and a processing module such as a digital signal processor (DSP) 124. In one embodiment, the antenna elements 118 and 120 may be embedded or internal to the wireless device 102. As will be apparent to those skilled in the field of communications, the particular design of the communication subsystem 112 depends on the wireless network 104 in which the wireless device 102 is intended to operate.

The wireless device 102 may send and receive communication signals over the wireless network 104 after the required network registration or activation procedures have been completed. Signals received by the antenna 118 through the wireless network 104 are input to the receiver 114, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 124. In a similar manner, signals to be transmitted are processed, including modulation and encoding, for example, by the DSP 124. These DSP-processed signals are input to the transmitter 116 for digital-to-analog (D/A) conversion, frequency up conversion, filtering, amplification, and transmission to the wireless network 104 via the antenna 120. The DSP 124 not only processes communication signals, but also provides for receiver and transmitter control. For example, the gains applied to communication signals in the receiver 114 and the transmitter 116 may be adaptively controlled through automatic gain control algorithms implemented in the DSP 124.

Network access is associated with a subscriber or user of the wireless device 102 via a memory module, such as a memory module 130, which may be a Subscriber Identity Module (SIM) card for use in a GSM network or a USIM card for use in a UMTS. The SIM card is inserted in or connected to an interface 132 of the wireless device 102 in order to operate in conjunction with the wireless network 104. Alternatively, the wireless device 102 may have an integrated identity module for use with systems such as Code Division Multiple Access (CDMA) systems.

The wireless device 102 also includes a battery interface 136 for receiving one or more rechargeable batteries 138. The battery 138 provides electrical power to at least some of the electrical circuitry in the wireless device 102, and the battery interface 136 provides a mechanical and electrical connection for the battery 138. The battery interface 136 is coupled to a regulator (not shown) which provides power V+ to the circuitry of the wireless device 102.

The wireless device 102 includes a microprocessor 140 which controls the overall operation of the wireless device 102. Communication functions, including at least data and voice communications, are performed through the communication subsystem 112. The microprocessor 140 also interacts with additional device subsystems such as a display 142, a flash memory 144, a random access memory (RAM) 146, a read-only memory (ROM) 148, auxiliary input/output (I/O) subsystems 150, a data port such as serial port 152, a keyboard or keypad 154, a speaker or audio port 156 for connecting to, for example a set of headphones, a microphone 158, a clickable thumbwheel or thumbwheel 160, a short-range communications subsystem 162, and any other device subsystems generally designated as 164. Some of the subsystems shown in FIG. 1 perform communication-related functions, whereas other subsystems may provide “resident” or on-device functions. Notably, some subsystems, such as the keypad 154, the display 142, and the clickable thumbwheel 160, for example, may be used for both communication-related functions, such as entering a text message for transmission over the wireless network 104, and executing device-resident functions such as a calculator or task list. Operating system software used by the microprocessor 140 is preferably stored in a persistent store such as the flash memory 144, which may alternatively be the ROM 148 or similar storage element. Those skilled in the art will appreciate that the operating system, specific device applications, or parts thereof, may be temporarily loaded into a volatile store such as the RAM 146.

The microprocessor 140, in addition to its operating system functions, enables execution of software applications on the wireless device 102. A predetermined set of applications that control basic device operations, including data and voice communication applications, will normally be installed on the wireless device 102 during or after manufacture. The wireless device 102 may include a personal information manager (PIM) application having the ability to organize and manage data items relating to a user such as, but not limited to, instant messaging, email, calendar events, voice mails, appointments, and task items. The wireless device 102 may also include a media player application for playing media files such as video files (e.g., .VOB, .AVI, .WMV, or .MPG), audio files (e.g., .MP1, .MP3, .MP4, .AAC, .WAV), or any other type of media file known to those skilled in the art. Naturally, one or more memory stores are available on the wireless device 102 to facilitate storage of media file data items and other information, such as the flash memory 144, the RAM 146, the ROM 148, the memory module 130, or other types of memory storage devices or FLASH memory cards represented by the other device subsystems 164, such as Secure Digital (SD) cards or mini-SD cards, etc.

The PIM and/or media applications have the ability to send and receive data items via either the wireless network 104 or a link to a computer system. The link to the computer system may be via the serial port 152 or the short-range communications subsystem 162. In one embodiment, PIM and/or media data items are seamlessly combined, synchronized, and updated via the wireless network 104, with the wireless device user's corresponding data items stored and/or associated with a host computer system thereby creating a mirrored or partially mirrored host computer on the wireless device 102 with respect to such items. This is advantageous where the host computer system is the wireless device user's office computer system. Additional applications may also be loaded onto the wireless device 102 through the wireless network 104, the auxiliary I/O subsystem 150, the serial port 152, the short-range communications subsystem 162, or any other suitable subsystem 164, and installed by a user in the RAM 146 or a non-volatile store such as the ROM 148 for execution by the microprocessor 140. Such flexibility in application installation increases the functionality of the wireless device 102 and may provide enhanced on-device functions, communication-related functions, or both. For example, secure communication applications may enable electronic commerce functions and other such financial transactions to be performed using the wireless device 102.

In a data communication mode, a received data signal representing information such as a text message, an email message, a media file to be transferred, or Web page download will be processed by the communication subsystem 112 and input to the microprocessor 140. The microprocessor 140 will further process the signal for output to the display 142 or alternatively to the auxiliary I/O device 150. A user of the wireless device 102 may also compose data items, such as email messages, for example, using the keypad 154 and/or the clickable thumbwheel 160 in conjunction with the display 142 and possibly the auxiliary I/O device 150. The keypad 154 may be either a complete alphanumeric keypad or telephone-type keypad. These composed items may be transmitted through the communication subsystem 112 over the wireless network 104 or via the short range communication subsystem 162.

For voice communications, the overall operation of the wireless device 102 is similar, except that the received signals would be output to the speaker or audio port 156 and signals for transmission would be generated by a transducer such as the microphone 158. Alternative voice or audio I/O subsystems, such as a voice message recording subsystem, may also be implemented on the wireless device 102. Although voice or audio signal output is typically accomplished primarily through the speaker or audio port 156, the display 142 may also be used to provide an indication of the identity of a calling party, duration of a voice call, or other voice call related information. Stereo headphones may also be used in place of the speaker 156.

The serial port 152 is normally implemented in a personal digital assistant (PDA) type communication device for which synchronization with a user's computer is a desirable, albeit optional, component. The serial port 152 enables a user to set preferences through an external device or software application and extends the capabilities of the wireless device 102 by providing for information, media file, or software downloads to the wireless device 102 other than through the wireless network 104. The alternate download path may, for example, be used to load media files onto the wireless device 102 through a direct, reliable and trusted connection to thereby provide the user of the device 102 with media files to view and/or listen to using a media application of the device 102.

The short-range communications subsystem 162 is an additional optional component which provides for communication between the wireless device 102 and different systems or devices, which need not necessarily be similar devices. For example, the subsystem 162 may include an infrared device and associated circuits and components, or a wireless bus protocol compliant communication mechanism such as a Bluetooth™ communication module to provide for communication with similarly-enabled systems and devices (Bluetooth™ is a registered trademark of Bluetooth SIG, Inc.). In another embodiment, the short-range communications subsystem 162 may be a wireless networking communications subsystem, conforming to IEEE 802.11 standards such as 802.11b, 802.11g, 802.11n or 802.16 standards.

Reference is next made to FIG. 2, which shows a communication system 200 suitable for use with the wireless device 102 shown in FIG. 1. The communication system 200 generally includes one or more wireless devices 102 (only one of which is shown in FIG. 2) and the wireless network 104. The wireless network 104 may include a wireless Wide Area Network (WAN) 202, a Wireless Local Area Network (WLAN) 204, and/or other interfaces 206 (which may not necessarily be wireless).

Referring to FIG. 2, the wireless WAN 202 may be implemented as a packet-based cellular or mobile network that includes a number of base stations 208 (one of which is shown in FIG. 2) where each of the base stations 208 provides wireless Radio Frequency (RF) coverage to a corresponding area or cell. The wireless WAN 202 is typically operated by a wireless network service provider that sells subscription packages to users of the wireless devices 102. The wireless WAN 202 comprises a number of different types of networks, for example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution), UMTS (Universal Mobile Telecommunications Systems), or Evolution-Data Optimized (EV-DO).

As shown in FIG. 2, the communications system 200 also includes a wireless network gateway 210 and one or more network provider systems 212. The wireless network gateway 210 provides translation and routing services between the network provider system(s) 212 and the WAN 202, which facilitates communication between the wireless devices 102 and other devices (not shown) connected, directly or indirectly, to the network provider system 212.

The WLAN 204 comprises a network which in some examples conforms to IEEE 802.11 standards such as 802.11b, 802.11g, or 802.11n or 802.16 standards; however, other communications protocols may also be used for the WLAN 204. The WLAN 204 includes one or more wireless RF Access Points (AP) 214 (one of which is shown in FIG. 2) that collectively provide a WLAN coverage area. For the embodiment depicted in FIG. 2, the WLAN 204 is operated by an enterprise (for example, a business or university in a building or campus type environment) and the access points 214 are connected to an access point (AP) interface 216. The AP interface 216 provides translation and routing services between the access points 214 and the network provider system 212 to facilitate communication between two or more of the wireless devices 102 and other devices (e.g., such as desktop computers) connected, directly or indirectly, to the network provider system 212. The AP interface 216 is implemented using a computer, for example, a server running a suitable computer program or software.

According to one embodiment, the other interfaces 206 may be implemented using a physical interface indicated by reference 218. The physical interface 218 includes an Ethernet, Universal Serial Bus (USB), Firewire, or infrared (IR) connection implemented to exchange information between the network provider system 212 and the wireless device 102.

The network provider system 212 comprises a server or server modules or a number of servers or server modules which are typically located behind a firewall (not shown). The network provider system 212 may include a number of modules including a mobile data delivery module 220. Various modules running on the network provider system 212 may be implemented as a number of services running on a single server or as a number of interconnected servers each running a software program to implement the functionality of the respective module. The network provider system 212 provides access for the wireless devices 102, through either the wireless WAN 202, the WLAN 204, or the other connection 206 to the devices connected, for example, through an enterprise network 224 (e.g., an intranet), to the network provider system 212. In one embodiment, the data delivery module 220 is implemented on a computer, such as the network provider system 212.

The enterprise network 224 comprises a local area network, an intranet, the Internet, a direct connection, or combinations thereof. The enterprise network 224 may comprise an intranet for a corporation or other type of organization. In at least some embodiments, the network provider system 212 is part of the enterprise network 224, and is located behind a corporate firewall and connected to the wireless network gateway 210 through the Internet. A computer 222 (e.g., a desktop or laptop computer) belonging to the user of the wireless device 102 is typically connected to the enterprise network 224. As described earlier, the wireless device 102 may be temporarily and directly connected to the computer 222 using, for example, the serial port 152. Alternatively, the wireless device 102 may communicate with the computer 222 using the communication subsystem 112 and the WAN 202 and/or the short-range communications subsystem 162 and the WLAN 204.

As shown in FIG. 2, an application/content server 226 may be connected to the enterprise network 224 and also to another network, for example a Wide Area Network (WAN) 228. In some embodiments, an email server 232 and/or the content server 226 form part of the enterprise network 224. The WAN 228 may further connect to other networks. The WAN 228 may comprise or be configured with the Internet, a direct connection, a LAN, a wireless communication link, or any combination thereof. Content providers, such as Web servers, may be connected to the WAN 228, an example of which is shown in FIG. 2 as an origin server 230.

According to one embodiment, the mobile data delivery module 220 provides connectivity between the wireless WAN 202 and the WLAN 204 and the other connection 206 and devices and/or networks connected directly or indirectly to the network provider system 212. In one embodiment, the connectivity provided may be Hypertext Transfer Protocol (HTTP) based connectivity providing an Internet based service connection to devices connected to the wireless WAN 202, the WLAN 204, or the other connection 206 and devices and/or networks connected directly or indirectly to the network provider system 212. The network 224, the application/content server 226, the WAN 228, and the origin server 230, are individually and/or collectively in various combinations a content source for the network provider system 212. It will be appreciated that the system shown in FIG. 2 comprises but one possible communication network or configuration of a multitude of possible configurations for use with the wireless devices 102.

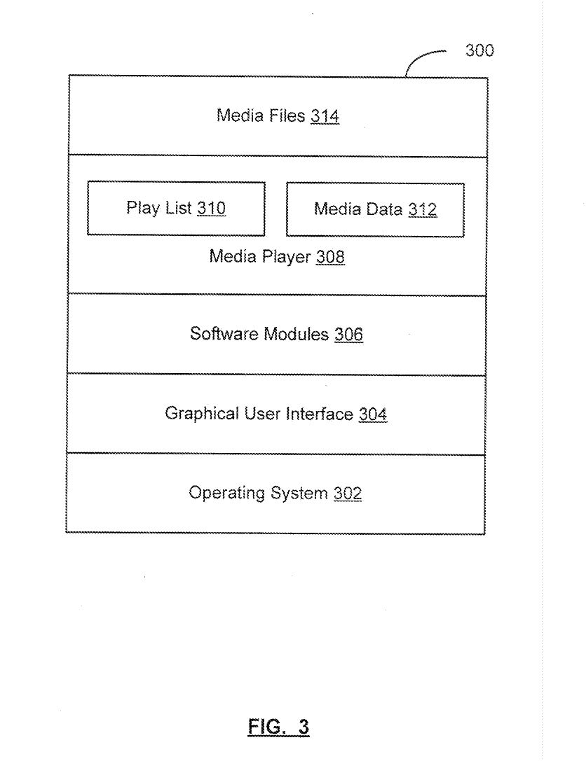

Reference is next made to FIG. 3, which shows a block diagram illustrating a memory 300 of the wireless device 102. The memory 300 has various software components for controlling the wireless device 102 and may include, for example, the flash memory 144, the RAM 146, the ROM 148, the memory module 130 and/or the other device subsystems 164. In accordance with one embodiment, the wireless device 102 is a portable media player intended to allow the user to listen to audio files and/or watch video files on the go. In accordance with another embodiment, the wireless device 102 is intended to be a multi-tasking wireless communications device configured for sending and receiving data items and for making and receiving voice calls that also includes a media player application enabling the user to listen to music and/or watch video files on the go. To provide a user-friendly environment to control the operation of the wireless device 102, an operating system (OS) 302 resident on the wireless device 102 provides a basic set of operations for supporting various applications typically operable through a graphical user interface (GUI) 304. For example, the operating system 302 provides basic input/output system features to obtain input from the auxiliary I/O 150, the keypad 154, the clickable thumbwheel 160, and other input devices, and to facilitate output to the user via the display 142. The GUI 304 is typically a component of the operating system 302. One or more software modules 306 for managing communications or providing a personal digital assistant (PDA) or other functions may also be included.

The memory 300 also includes an email and calendar client, which may be combined in, for example, a PIM application having email-based calendaring and scheduling functions. Typically, the PIM is installed as one of the software modules 306. The memory 300 also includes a media player application 308 for playing media files 314 that are stored in the memory 300. Typically, the media files 314 would be stored in the flash memory 144, but may be stored in any of the memory devices associated with the memory 300 such as removable memory cards, for example SD or mini-SD cards. The media player application 308 may further maintain in the memory 300 one or more playlists 310 and media data 312. In one embodiment, the playlists 310 are used by the media player application 308 to manage the playing of media selected from the media files 314, stored locally on the wireless device 102. The media data 312 may include any data about the media files 314 that the media player application 308 stores. Media may be available from an external source, for example media stored on the user's computer 222, that may be selected for copying to the wireless device 102 and for adding to and/or replacing the media files 314. The selection of available media from the computer 222 may also be stored as the media data 312. The media data 312 may also include metadata containing information about the media files 314.

Thus, the wireless device 102 includes computer executable programmed instructions for directing the wireless device 102 to implement various applications. The programmed instructions may be embodied in the one or more software modules 306 resident in the memory 300 of the wireless device 102. Alternatively, the programmed instructions may be tangibly embodied on a computer readable medium (such as a DVD, CD, floppy disk or other storage media) which may be used for transporting the programmed instructions to the memory 300 of the wireless device 102. Alternatively, the programmed instructions may be embedded in a computer-readable, signal-bearing medium that is uploaded to the wireless network 104 by a vendor or supplier of the programmed instructions, and this signal-bearing medium may be downloaded through one or more of the interfaces 112, 150, 152, 162 to the wireless device 102 from, for example, the wireless network 104 by end users.

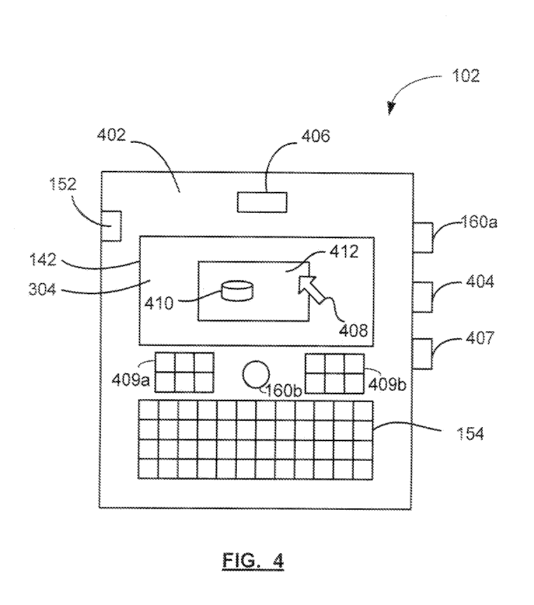

Reference is next made to FIG. 4, which shows a front view of the wireless device 102. As mentioned above, the wireless device 102 may be a data and voice-enabled handheld device. The wireless device 102 includes a casing 402, the data or serial port 152, the display screen 142, the graphical user interface (GUI) 304, the keypad 154, the clickable thumbwheel 160a or other device for navigation such as a trackball 160b, one or more input buttons 404 (e.g., select, cancel, talk, play, stop, fast forward, rewind, next, previous buttons), signal inputs/outputs 406 (e.g., power connector input, microphone, speaker, data interface input, etc.), and an audio port 407. Additionally, the wireless device 102 may have a number of navigation control buttons 409a and 409b. The navigation control buttons 409 may provide a number of functions such as a send and/or end key for a mobile telephone application of the wireless device 102, a menu key, an escape key, etc. The functions of the navigation control buttons 409 may be user configurable. Internally, the wireless device 102 includes one or more circuit boards (not shown), the microprocessor 140 (FIG. 1), the memory 300 (FIG. 3), the battery 138 (FIG. 1), the antennae 118, 120 (FIG. 1), etc., which may all be coupled to the signal inputs/outputs 406, the keypad 154, the display screen 142, the clickable thumbwheel 160, etc.

The microprocessor 140 is typically coupled to one or more input devices (e.g., the buttons 404, the keypad 154, the clickable thumbwheel 160) for receiving user commands or queries and the display 142 for displaying the results of these commands or queries. For example, user queries may be transformed into a combination of commands for producing one or more tables of output data which may be incorporated in one or more display pages for presentation to the user. The microprocessor 140 is also coupled to the memory 300. The microprocessor 140 is typically coupled to a set of stereo headphones connected to either the audio port 407 or connected via a Bluetooth connection when the user wishes to use the media player application 308 to listen to audio files or watch video files.

A user may interact with the wireless device 102 and its software modules 306 and the media player module 308 using the GUI 304. The GUI 304 is controlled by the operating system 302 (FIG. 3) and provides a display format enabling the user to choose commands, execute application programs, manage computer files, and perform other functions by selecting pictorial representations (i.e., icons), or selecting items from a menu through the use of an input or pointing device such as the clickable thumbwheel 160 and/or the keypad 154. Generally, the GUI 304 is used to convey information and receive commands from users and generally includes a variety of GUI objects or controls including icons, toolbars, drop-down menus, pop-up menus, text, dialog boxes, buttons, etc. A user typically interacts with the GUI 304 presented on the display 142 by using an input or pointing device to position a pointer or cursor 408 over an object 410 (i.e., “pointing” at the object) and by “clicking” on the object 410 (e.g., by depressing the thumbwheel 160 or a button on the keyboard 154, etc.). This is often referred to as a point-and-click or selection operation. Typically, the objet 410 may be highlighted (e.g., shaded) when it is selected or pointed at by the pointer or cursor 408 to indicate that the object 410 is selectable.

Typically, a GUI-based system presents application, status, and other information to the user in windows appearing on the display 142. A window 412 is a display area shown within the display 142, typically rectangular, in which a user may view an application or document. The window 412 may be open, closed, displayed full screen, reduced to an icon, increased or reduced in size, or moved to different areas of the display 142. Multiple windows 412 may be displayed simultaneously. For example, the windows 412 may be displayed within other windows, overlapped with other windows, or filed within the display area.

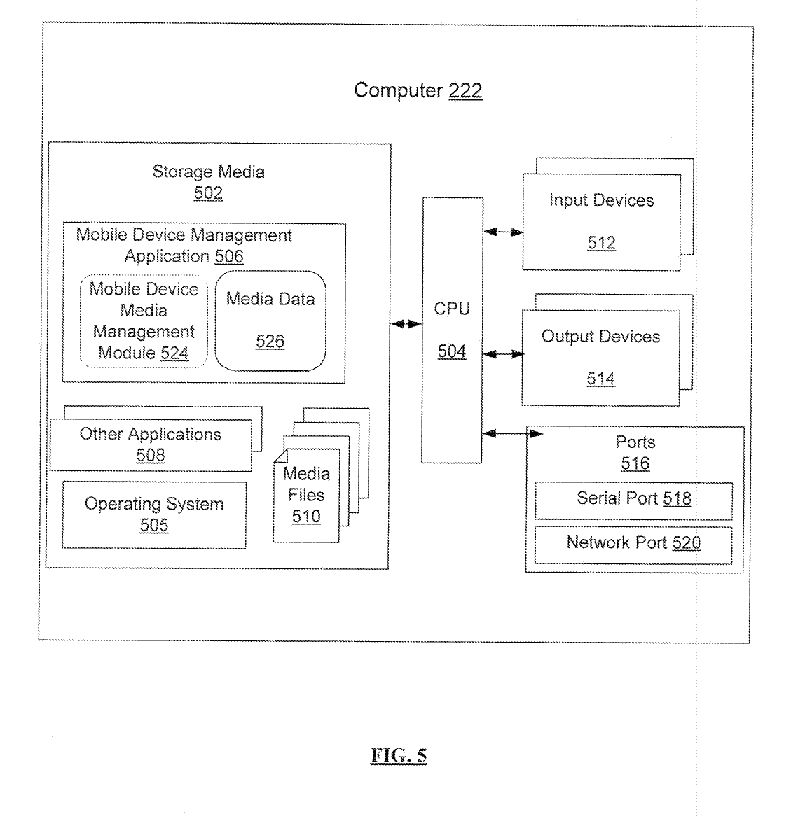

Reference is next made to FIG. 5, which is a block diagram illustrating an example of the computer 222, which includes one or more storage media 502 in communication with a central processing unit (CPU) 504. Although the storage media 502 is typically one or more hard-disk drives, the storage media 502 could additionally or alternatively include DVD media, CD media, flash memory, diskettes, RAM and/or other types of media. In some embodiments, various types of software are stored on the media 502 including an operating system 505, a mobile device management application 506 and other applications 508. Also stored on the media 502 are media files 510 and media data 526.

The computer 222 further includes one or more input devices 512, one or more output devices 514, and one or more communications subsystems or ports 516 in communication with the CPU 504. Examples of possible input devices include a mouse, keyboard, scanner, microphone, etc. Many of the input devices 512 may not be housed within the computer 222, but may instead provide input through one of the externally exposed ports 516. Examples of the possible output devices 514 include a monitor, a printer, speakers, etc. Many of the output devices 514 may not be housed within the computer 222 and, as such, output signals from the CPU 504 to one of the devices 514 may be transmitted through one of the ports 516. As will be appreciated by those skilled in the art, it is also possible that one or more of the devices 512 and 514 may be a device that is more accurately described as both an input and output device. In an example embodiment, the ports 516 include a serial port 518, such as a USB port, for example for supporting a wired connection to the serial port 152 of the wireless device 102 (FIG. 1) connected either directly or indirectly through a docking station (not shown). In one embodiment, the ports 516 also include a network port 520 for connecting to the network 224 (FIG. 2). The port 520 may comprise an Ethernet 10/100/1000 connector and/or a WLAN communications sub-system. A short-range wireless communications port or antenna may be included for supporting direct wireless communications such as 802.11b/g/n or 802.16 wireless networking, Bluetooth™, or infrared communications with either the wireless device 102 or the wireless network 104.

As indicated above, among the software applications on % the computer 222 is a mobile device management application 506 (for suite of applications) which includes computer instructions that are executable by the CPU 504 of the computer 222 to implement, among other things, a portable device media management module 524 that facilitates the management of and transfer of media files from the computer 222 to the wireless device 102 that is associated with the computer 222. By way of example, the computer 222 and the wireless device 102 may be associated through a common user who has an assigned domain login ID and email account within the system 200. The wireless device 102 may be associated with the user domain ID and email account during activation. When a user logs onto a particular computer 222 using the domain login ID, both the computer 222 and the wireless device 102 are commonly associated with the user and hence each other. Association of the wireless device 102 with the computer 222 could also occur through other means, for example, when a user originally activates the wireless device 102, the wireless device 102 and the computer 222 may exchange IDs and/or addresses by being plugged directly together through a serial connection. In another example, the device may, upon activation, search for other devices through the short-range communications system 162 and present the user with a list of devices to “pair” with; the wireless device 102 and the selected device (e.g., the computer 222) then authenticate each other via a password exchange, and, once paired, the associated devices remember the pairing and password so that future linking between the device is automatically performed.

The present application contemplates a number of features for improving the functionality of a media player application (e.g., the media player application 308) running on a wireless device (e.g., the wireless device 102). In one example, where the wireless device 102 has both media playing capabilities and voice capabilities such as cellular or mobile telephone capabilities, the media files 314 may include both music files and ring tone files stored together as the media files 314. The music files and ring tone files may even share the same file type and file extension (e.g., .MP3 files). However, music files and ring tone files occupy different categories of media in the sense that they are treated differently in how they are played, displayed to the user, etc. Therefore, in one example, when the user uses the media player application 308 to view a list of all of the media files stored on the wireless device 102 (e.g., such as the media files 314), the media player application 308 does not show the user the ring tone files stored in the memory 300. This may be accomplished in a number of ways. For example, upon displaying the media files stored in the memory 300, the media player application may extract and examine metadata associated with each of the media files 314 to determine if each media file is a ring tone file. Such metadata may be stored, for example, as ID3 tags within .MP3 files. Alternatively, such metadata may be stored as the media data 312 when the media files 314 are copied to the memory 300 of the wireless device 102. In yet another example, ring tones may be stored in a different directory or folder created in the memory 300, such as a specific “ring tone” directory, which is specifically excluded from audio lists by the media player application 308.

The media player application 308 may also be programmed to find all of the audio files in the memory 300 (e.g., in either the flash memory 144 or a mini-SD card inserted into the wireless device 102), regardless of which directories or folders the audio files reside in. For example, the media player application 308 may present to the user all audio files found on the wireless device 102, except for ring tone files. Conversely, when a user wishes to view only the ring tones found in the memory 300, for example while using a cellular telephone configuration application stored as one of the software modules 306, the application may display to the user only the ring tone files that are found. Again, the configuration application may identify ring tones based on metadata stored within the ring tone files, metadata stored as the media data 312, or based on the location of the ring tone files in a “ring tone specific” directory.

With the current memory limitations found in typical wireless devices such as the wireless device 102, it is often not feasible to carry around a significant amount of video stored in the memory 300. As such, introducing a folder structure into the media player application 308 for organizing video files stored as the media files 308 would be overkill for relatively simple operations that work with a relatively small list of files. Therefore, the media player application 308 may provide the functionality to scour the memory 300 for all of the media files 314 that are video files. This may be determined in a number of ways, such as by examining metadata associated with the video files (e.g., either within the video files or saved as the media data 312) or simply by examining the file extensions or directory or folder placements of the video files. Any and all video files that are found are displayed in a video list. In one example, the video list may have a flat hierarchy that aims to show all videos on a single list that is scrollable, if the list is longer than the display 142.

Users of the computer 222 may use the mobile device media management module 524 of the mobile device management application 506 to manage the media files 314 and associated playlist 310 of the wireless device 102. The media management module 524 may offer the ability to create a playlist and transfer the playlist to the wireless device 102 (e.g., to be saved as the playlist 310). The media player application 308 may search the memory 300 and find all playlists 310 that are available to the user of the wireless device 102, regardless of the specific location of the playlist 310 in the memory 300. In one example, playlists are most easily identifiable by a file extension (e.g., .m3u), but may also be identifiable by metadata stored either within the playlist 310 file or saved as the media data 312. Playlists saved in the memory 300 may reference the media files 314 stored anywhere within the memory 300. Thereof, the playlist 310 may reference the media files 314 stored in different directories or on different storage devices.

The media management module 524 that runs on the computer 222 is responsible for managing the playlists 310 of the media player application 308 that runs on the wireless device 102. This allows users to easily create and/or modify playlists on the computer 222 and transfer the playlists to the memory 300 of the wireless device 102. Naturally, a playlist is not of much use without the media files to which the playlist refers. Therefore, the present application also contemplates that the media management module 524 automatically copies all media files associated with a playlist to the memory 300 of the wireless device 102 when the playlist is copied to the memory 300 and saved as the playlist 310. This ensures that users will not have to manually copy over each media file referenced by a newly created or edited play list, which may otherwise cause cumbersome referencing and pointer issues. Additionally, the present application contemplates an intelligent copying feature that aims to ensure two items. Firstly, media files that are transferred to the memory 300 along with the playlist 310 are properly referenced in the playlist 310 file (e.g., an .m3u file). In one example, the playlist 310 .m3u file may be a text file comprising pointers to the associated media files 314. Secondly, media files that are already resident in the memory 300 are not copied again from the storage media 502 of the computer 222 to the memory 300 if the media files are the same and have not changed. If a media file has been modified, for example to insert updated or more ID3 tag information, then the media file will be copied to the memory 300 again, thus overwriting the existing copy of the file in the memory 300. This feature has the potential to greatly reduce the amount of time required to synchronize the wireless device 102 with the computer 222 after any media management has been performed by the user using the media management module 524 of the computer 222.

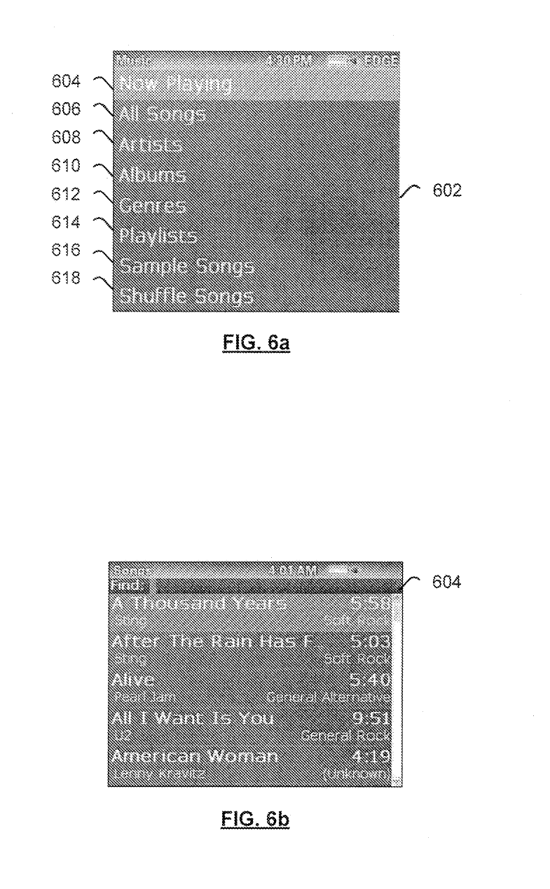

Reference is next made to FIGS. 6a and 6b, which show screen images of a media player application, for example the media player application 308 running on the wireless device 102, in accordance with one embodiment. Referring to FIG. 6a, a menu 602 is shown. The menu 602 is available within the media player application 308 when the user chooses to view media files available for listening and/or viewing using the media player application 308. In one example, the media files are audio files stored as the media files 314 in the memory 300. The menu 602 presents the user with a number of options, which include: (a) Now Playing (reference 604), which allows the user to view a listing of the audio file or files that are currently playing or are scheduled to be played, if audio file(s) are currently playing; (b) All Songs (reference 606), which allows the user to view a listing of all songs available on the wireless device 102 (e.g., in the memory 300 stored as the media files 314) for listening; (c) Artists (reference 608), which allows the user to view a listing of the available audio files presented, organized and/or sorted by Artist name; (d) Albums (Reference 610), which allows the user to view a listing of the available audio files presented, organized, and/or sorted by the album to which the audio files belong; (e) Genres (Reference 612), which allows the user to view a listing of the available audio files presented, organized, and/or sorted according to the type of music to which the media files belong; (f) Playlists (Reference 614), which allows the user to view the play list(s) 310 that are available in the media player application 308; (g) Sample Songs (Reference 616), which allows the user to view a listing of any sample songs that are saved as the audio files 314 (e.g., sample songs are usually distributed with a new wireless device 102 and/or a new installation of the media player application 308 to demonstrate the capabilities of the device 102 and/or the application 308); and (h) Shuffle Songs (Reference 618), which simply allows the user to listen to all of the available audio files in a shuffled playback format.

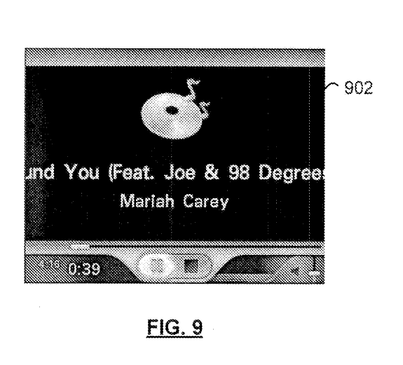

Referring to FIG. 6b, a menu 604 is shown, displaying a list of audio files that are available for listening. The menu 604 is shown to the user in response to the user choosing the “All Songs” 606 option in the menu 602. From a menu, such as the menu 604, the user may select one or more audio files for playback in the media player application 308, an example of which is shown in connection with FIG. 9.

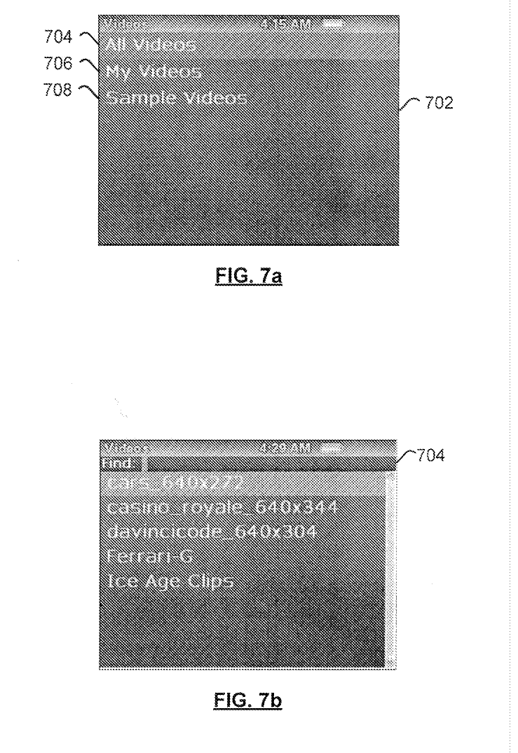

Reference is next made to FIGS. 7a and 7b, which show screen images of a media player application, for example the media player application 308 running on the wireless device 102. Referring to FIG. 7a, a menu 702 is shown. The menu 702 is available within the media player application 308 when the user chooses to view media files available for listening and/or viewing using the media player application 308. In one example, the media files are video files stored as the media files 314 in the memory 300. The menu 702 presents the user with a number of options, which include: (a) All Videos (Reference 704), which allows the user to view a listing of all videos available on the wireless device 102 (e.g., in the memory 300 stored as the media files 314) for viewing and/or listening; (b) My Videos (Reference 706), which allows the user to view a listing of all videos available on the wireless device 102 that have, for example, been recorded by the user of the wireless device 102 using an integrated camera in the wireless device 102; and (c) Sample Videos (Reference 708), which allows the user to view a listing of any sample videos that are saved as the media files 314. For example, sample videos are usually distributed with a new wireless device 102 or a new installation of the media player application 308 to demonstrate the capabilities of the device 102 and/or the application 308. The menu 702 presents the user with less options than the menu 704 because video files typically require much larger amounts of storage space than audio files and therefore each occupy much larger portions of the memory 300 on the wireless device 102. As a result, the wireless device 102 is likely to have few videos stored in the memory 300. Therefore, a substantial management and/or navigational menu system is not needed to manage video files, as opposed to audio files that are typically numerous and where the user benefits from the more substantial menu system shown in connection with FIG. 6a.

Referring to FIG. 7b, a menu 704 is shown, displaying a list of video files that are available for viewing and/or listening. The menu 704 is shown to the user in response to the user choosing the “All Videos” option in the menu 702. From a menu, such as the menu 704, the user may select one or more video files for playback in the media player application 308, an example of which is shown in connection with FIG. 9.

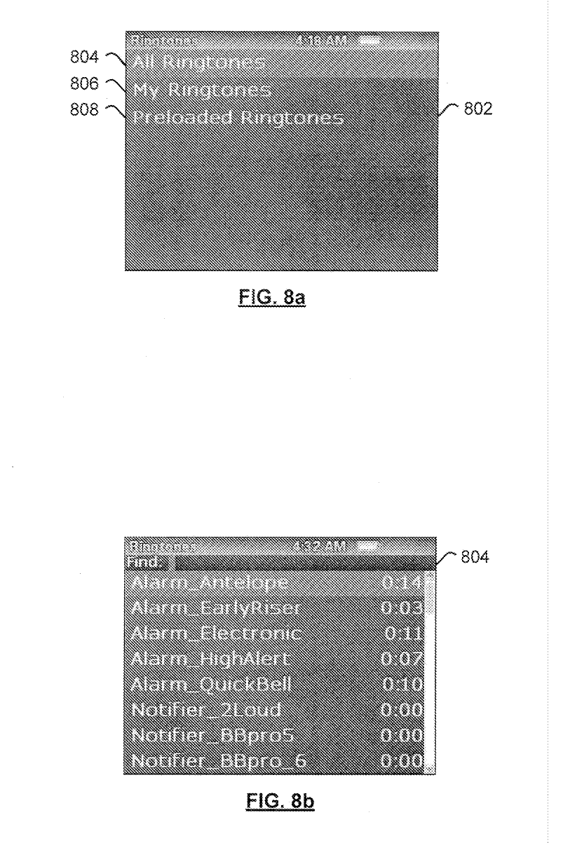

Reference is next made to FIGS. 8a and 8b, which show screen images of a media player application, for example the media player application 308 running on the wireless device 102, in accordance with one embodiment. Referring to FIG. 8a, a menu 802 is shown. The menu 802 is available within the media player application 308 when the user chooses to view media files available for listening and/or viewing using the media player application 308. In one example, the media files are ring tone files stored as the media files 314 in the memory 300. The menu 802 presents the user with a number of options, which include: (a) All Ring Tones (Reference 804), which allows the user to view a listing of all ring tones available on the wireless device 102 (e.g., in the memory 300 stored as the media files 314) for viewing and/or listening; (b) My Ring Tones (Reference 806), which allows the user to view a listing of all ring tones available on the wireless device 102 that have, for example, been downloaded or customized by the user of the wireless device 102; and (c) Preloaded Ring Tones (Reference 808), which allows the user to view a listing of any preloaded ring tones that are saved as the media files 314. For example, preloaded ring tones are usually distributed with a new wireless device 102 to allow the user of the wireless device 102 to select a ring tone for use with a cellular or mobile phone component of the wireless device 102. The menu 802 may present the user with less options than the menu 602 because ring tone files are typically used relatively sparingly with a limited number of selections and therefore occupy a relatively smaller portion of the memory 300 on the wireless device 102 as compared to other media files. Therefore, a substantial management and/or navigational menu system is not needed to manage ring tone files, as opposed to other media files that are typically numerous and where the user benefits from the more substantial menu system shown in connection with FIG. 6a.

Referring to FIG. 8b, a menu 804 is shown, displaying a list of ring tone files that are available for listening. The menu 804 is shown to the user in response to the user choosing the “All Ring Tones” option in the menu 802. From a menu, such as the menu 804, the user may select one or more ring tone files for playback in the media player application 308, an example of which is shown in connection with FIG. 9.

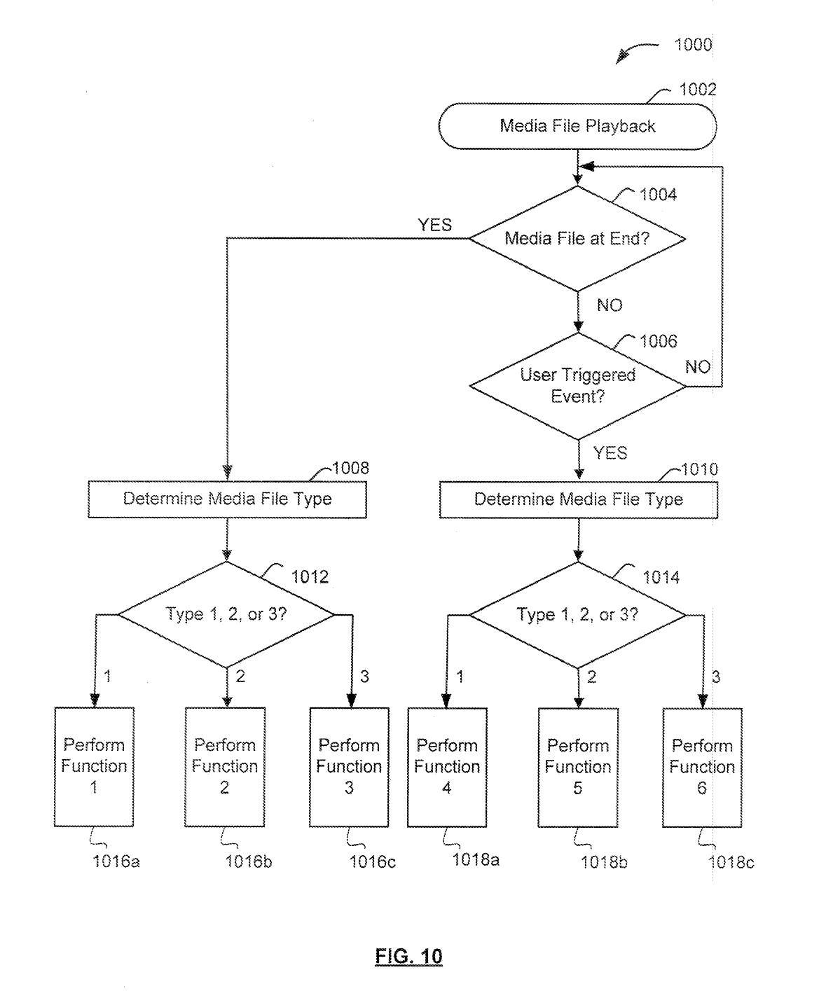

Reference is next made to FIG. 9, which shows a screen image 902 of a media player application (e.g., the media player application 308) playing a media file. In the example shown in FIG. 9, the media player application 308 is playing an audio file of a song by Mariah Carey. In one embodiment, the media player application 308 treats various media files differently according to the type of media file being played. The media player application 308 may treat various media files differently when the playing of the media file either comes to an end or a user triggered event occurs, for example when the user either exits the media player application 308 or performs some function using the GUI 304 of the wireless device 102 that causes the media player application 308 to no longer be the application that is running in the forefront of the processes running on the wireless device 102. In another aspect, the user triggered event may involve the media player application 308 recognizing that the media file selected for playback is the same media file that was previously played. This playback “re-entry” may be treated differently depending on the type of media file selected for playback. The different treatment of different types of media files based on user triggered events or completed playback is described next in connection with FIG. 10.

Reference is next made to FIG. 10, which shows a flowchart illustrating a method 1000 of determining playback behavior in a media application. In a first step 1002 of the method 1000, the user has chosen to playback a media file by for example viewing and/or listening to one of the media files 314 stored in the memory 300 using, for example the media player application 308 as shown in FIG. 9. Upon initiating the media file playback using the media player application 308 (e.g., either by selecting one of the media files 314 for playback as described in connection with FIG. 6, 7, or 8, or by selecting a media file for playback in a file manager type application or folder of the GUT 304, which launches the media player application 308), the media player application 308 typically recognizes the type of file being played. In one example, the type of media file being played by the media player application 308 may be either an audio file (as described in connection with FIGS. 6a and 6b), a video file (as described in connection with FIGS. 7a and 7b), or a ring tone file (as described in connection with FIGS. 8a and 8b). The media player application 308 may recognize the type of file being played in a number of ways. For example, upon displaying the media flies 314 stored in the memory 300 (e.g., before playing a specific media file), the media player application 308 may extract and examine metadata associated with each of the media files 314 to determine if each media file is a ring tone file, another type of audio file, or a video file. Such metadata may be stored, for example, as ID3 tags within .MP3 files. Alternatively, such metadata may be stored as the media data 312 when the media files 314 are copied to the memory 300 of the wireless device 102. In yet another example, ring tones may be stored in a different directory or folder created in the memory 300, such as a specific “ring tone” directory, while other types of media files are stored in their respective directories, for example, a “video” directory for video related media files and a “music” directory for music related media files. In the case where the media player application 308 is launched by the selection of a media file from a different application, such as a file management application, the media player application 308 retrieves this metadata upon opening the media file being launched. The metadata associated with the media file currently being played by the media player application 308 is typically stored at least temporarily in the RAM 146.

The method 1000 monitors the playback of the media file for a number of events. In the example shown in FIG. 10, the method 1000 monitors the playback of the media file for the arrival at the end of the media file at a step 1004. The method 1000 further monitors the playing of the media file for a user triggered event at a step 1006. The user triggered event may include events such as the performing of an action outside of the media player application 308, which may include exiting of the media player application (e.g., hitting the escape key while the media player is playing) or the minimization of the media player application 308 to a background process, for example where the user clicks on another application that is running on the wireless device 102 or performs some other function while the media player application 308 is playing the media file.

In another aspect, the user may be browsing the available media files 314 and may re-initiate the playing of the same media file that is currently playing. Alternatively, the user may have previously exited the media player application 308 and may choose to initiate playback of the same media file for which playback was previously prematurely terminated or paused. The media player application 308, upon initiating playback of a media file at the step 1002, may load data from the memory 300 related to the media file previously played and the playback position of the previously played file upon termination. If the media file currently selected for playback is the same media file, this may be interpreted as one of the user triggered events at the step 1006.

If the media file being played arrives at its end, the method 1000 proceeds to a step 1008 where the media player application 308 determines the type of media file being played. Likewise, if the user triggered event occurs, the media player application 308 determines the type of media file being played at a step 1010. In most cases, the determination of the type of media file being played simply involves the media player application 308 retrieving from the RAM 146 the information indicating the type of media file being played that was previously determined and stored when the media file was loaded into the media player application 308. In some cases, the information may not exist in RAM and the media player application 308 may have to use the methods described above in order to determine the type of media file being played (e.g., either using metadata contained within the media file or stored as the media data 312 or based on the directory or folder location of the media file).

Each type of media file may be treated differently depending on whether the media file playback has reached the end or the user has performed some user triggered event. The type of media file being played may include but not be limited to for example a video file, a music file, or a ring tone file. After determining the type of media file being played, the method 1000 proceeds from the step 1008 to the step 1012 or from the step 1010 to the step 1014. The steps 1012 and 1014 perform the same function, namely deciding whether the media file being played is a first type (e.g., a video file), a second type (e.g., a music file), or a third type (e.g., a ring tone file).

The step 1012 proceeds to one of a number of additional steps, 1016a, 1016b, or 1016c, depending on the determination performed at the step 1012. For example, if it was determined that the file being played is a video file, the method proceeds to the step 1016a where a first function is performed. In one example, the first function involves terminating playback. The media player application 308 may further either revert back to an available media view, such as the menu 702 shown in FIG. 7a, or the media player application 308 may exit. These options are based on the expectation that the user will not likely want to automatically view another video after completing the viewing of a video. If it was determined that the file being played is a ring tone, the method proceeds to the step 1016b where a second function is performed. The second function may involve terminating playback. The media player may further either revert back to an available media view, such as the menu 802 shown in FIG. 8a, or the media player application 308 may exit. These options are based on the expectation that a user who is listening to a ring tone does not likely want to listen to further ring tones after completing the listening of a ring tone without first being prompted to do so. If it was determined that the file being played is a music file, the method proceeds to the step 1016c where a third function is performed. The third function may involve playing the next music file on a playlist or randomly selecting another music file for playback if the media player application 308 is in a random playback mode. These options are based on the expectation that a user who is listening to music files likely wants to listen to additional music files after completing the listening of a first music file.

The step 1014 proceeds to one of a number of additional steps, 1014a, 1018b, or 1018c, depending on the determination performed at the step 1014. For example, if it was determined that the file being played is a video file, the method proceeds to the step 1018a where a fourth function is performed. If the user exists or minimizes the media player application 308, the fourth function may involve stopping or pausing playback and saving in memory information relating to the current file being played back and the playback position at the time of the pause or stoppage (e.g., saved as the media data 312). These options are based on the expectation that the user who is performing other functions using the GUI 304 of the wireless device 102 does not likely want to continuing running the playback of a video file that he can no longer see, since another application or menu will have taken over the display 142. On the other hand, if the user triggered event comprises the user re-initiating playback of the same video file that was previously stopped or paused, the fourth function may involve loading from memory the stopped or paused playback position, since it is difficult to find the same position back in a video, so that the video playback proceeds from the same position at which the user previously stopped playback.

If it was determined at the step 1014 that the file being played is a ring tone, the method proceeds to the step 1016b where a fifth function is performed. The fifth function may involve stopping or pausing playback. These options are based on the expectation that the user who is performing other functions using the GUI 304 of the wireless device 102 does not likely want to continuing running the playback of a ring tone file, since the user was likely just previewing the ring tone and has now decided that he has heard enough. If the user re-initiates playback of the same ring tone, the fifth function may involve the playback simply beginning again from the beginning since ring tone files are typically short. This choice to begin playback from the beginning may be based on the media player application 308 determining that the information saved in the memory about the previously played file and the playback position relates to the ring tone being played. Alternatively, the termination of ring tone playback may not result in information being saved to the memory about the previously played media file and the re-initiation of ring tone file playback may not trigger a user-triggered event at the step 1006.

If it was determined at the step 1014 that the file being played is a music file, the method proceeds to the step 1016c where a sixth function is performed. The sixth function may involve continuing the playback of the music file despite the fact that the user is performing other functions using the GUT 304 of the wireless device 102. This is based on the expectation that a user who is listening to music files likely wants the playback to continue as he uses the wireless device 102 to perform other functions. Similarly, if the user reselects playback of the same music file while the music file is playing, the sixth function may involve continuing the playback of the music file without restarting the song.

While three possible media file types (i.e., video files, music files, and ring tones files) have been described resulting in three different types of treatment by the media player application 308 in two different scenarios (i.e., the media file arriving at an end or one of a number of user triggered events occurring), it will be understood that any number of types of media files may be treated in any number of ways, depending on the design criteria of a particular application and/or any configuration settings set by the user in the media player application 308. The user may use the media player application 308 to configure the first through sixth functions (i.e., steps 1016a-c and 1018a-c) to perform any function the user desires. Additionally, any number of scenarios may occur. In the example above, the steps 1008 and 1010 perform similar functions and the steps 1012 and 1014 perform similar functions. However, two distinct branches are shown for exemplary purposes because the end treatment of the media files by the media player application 308 (e.g., steps 1016a-c and 1018a-c representing six different functions) may be different. Therefore, any number of branches are possible depending on how many distinct events may occur during the playback of a media file. Similarly, a distinct branch could have been shown for each possible user triggered event mentioned above.

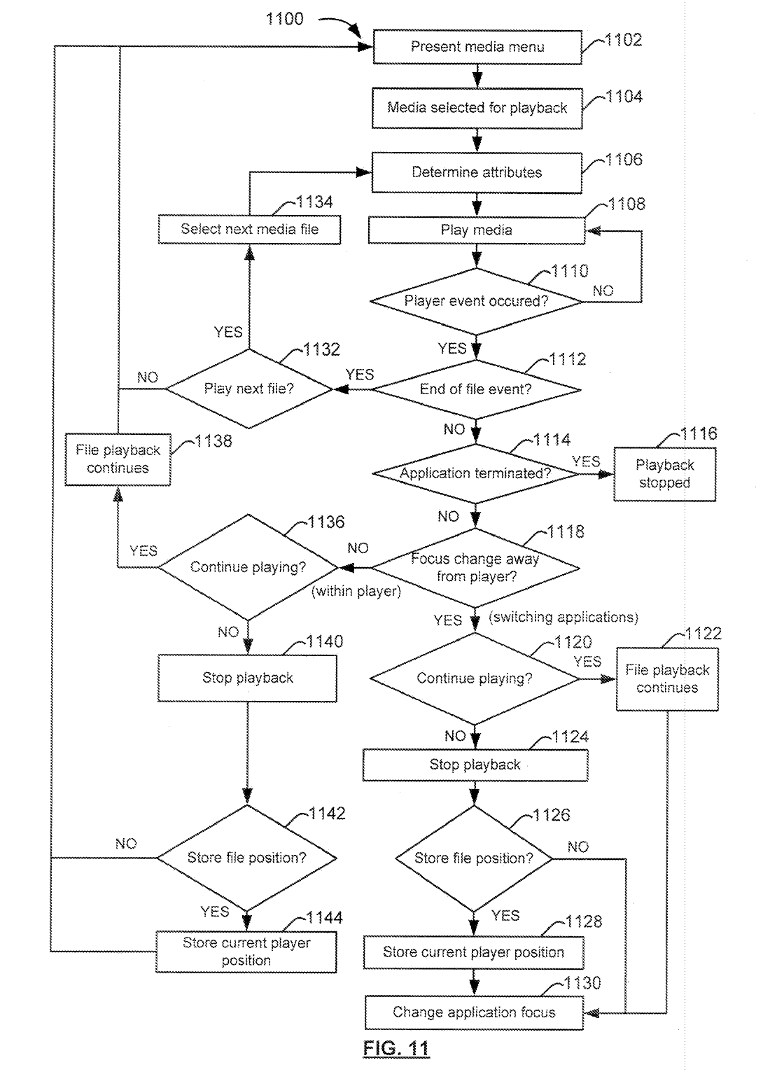

FIG. 11 illustrates an alternate method for determining playback behavior in a media application. The method 1100 starts with the user entering the media player application 308 and being presented with a media menu at step 1102. The user then selects the type of media he wishes to play such as video, music, ring tones, etc. The appropriate menu related to the media type is displayed to the user. The user then selects specific media for playback at step 1104, for example as shown in FIG. 6b. Attributes associated with the specific media file, or associated with the type of media, which for example may be defined by the file extension or folder containing the media, is retrieved at step 1106. The attributes many be defined by metadata stored in or associated with the media file or may also be contained in a separate file stored in the memory 300. In addition, playback position within the file, or other video or audio settings may be determined at step 1106.

The media is then played at step 1108 by the media player application 308 through the wireless device 102. During playback, an event may occur which will impact the media player application 308; the event may include but not be limited to the user selecting a different menu within the media player application 308, changing to another application for example by pressing the escape key, exiting the media player application 308 or playback reaching the end of the media file. If no player event has occurred at step 1110 the media continues playing at step 1108. If a player event does occur at step 1110, it must be determined what type of event has occurred.

If the end of the media file has been reached at step 1112, the metadata associated with file playback is determined. The metadata may indicate, for example if the media is part of a playlist or is in a directory such that all the media in the directory should be played sequentially, such as for song file. If the media is part of a playlist at step 1132, the next media file in the playlist or directory is selected at step 1134. The metadata associated with the next media file is then retrieved at step 1106. The playback preferences associated with the metadata may be dependent on the media type or media directory type. If no additional media files are to be played after the current file, determined at step 1132, the media menu is presented to the user at step 1102. Media such as video files or ring tones are generally not playlist type files and will allow the user to select the next file to be played. If the end of the media file has not been reached, as determined at step 1112, it is then determined if the media player application 308 has been terminated.

If the media player application 308 has been terminated, as determined at step 1114, playback is stopped for all media types at step 1116. If the media player application 308 has not been terminated then a user initiated event within the media player application 308 has occurred. The user may have selected to change focus within the media player application 308, for example by selecting a menu within the media player application 308 or by browsing the media directory. In this case, as determined at step 1118, metadata associated with the media file being played, such as metadata defining if the media file should still continue playing, is determined, for example music which may be played in the background is determined at step 1136. If the metadata defines that the media can play in the background at step 1136, the media player application 308 continues playing at step 1138 and the media menu or other display is provided to the user at step 1102. If the media file should not continue playing, as determined at step 1136, playback is stopped at step 1140. If the metadata identifies that the media file can have a playback position indicator associated with it, such as in a video file where the last location of viewing is saved, the step 1142 proceeds to step 1144 where the current player position is stored so that play can later resume from the same location. The media menu is then presented to the user at the step 1102. If no position indicator is indicated by the metadata, the step 1142 proceeds to step 1102 where the player position is not saved and the media menu is presented.

If focus has been shifted away from the media player application 308, for example by minimizing the player or moving to another application at step 1118, it is then determined if the media file should still continue playing at step 1120, for example music which may be played in the background. If the type of media may be played in the background, as determined at step 1120, playback continues at step 1122 and the media player application 308 may then operate in the background or be minimized at step 1130. If the media should not continue being played, as determined at step 1120, playback is stopped at step 1124. If the media file has a position identifier associated with it, such as in a video file where the last location of viewing is stored, the step 1126 proceeds to a step 1128 where the current player position is stored so that playback may later resume from the same location. If no position metadata is associated with a stored playback location of the media file, the step 1126 proceeds to the step 1130 where the player position is not saved and the application focus is changed. When the focus is moved back to the media player application 308, depending on the state of the media player application 308, the method would continue at step 1108, if media is already playing, or step 1102 if media playback had been stopped.

While the steps of the methods are shown as occurring in a particular order, it will be appreciated by those skilled in the art that many of the steps are interchangeable and may occur in different orders than that shown without materially affecting the end results of the methods.

While the present disclosure is primarily described as a method, a person of ordinary skill in the art will understand that the present disclosure is also directed to an apparatus for carrying out the disclosed method and including apparatus parts for performing each described method step, be it by way of hardware components, a computer programmed by appropriate software to enable the practice of the disclosed method, by any combination of the two, or in any other manner. Moreover, an article of manufacture for use with the apparatus, such as a prerecorded storage device or other similar computer readable medium including program instructions recorded thereon, or a computer data signal carrying computer readable program instructions may direct an apparatus to facilitate the practice of the disclosed method. It is understood that such apparatus, articles of manufacture, and computer data signals also come within the scope of the present disclosure.

The embodiments of the present disclosure described above are intended to be examples only. Those of skill in the art may effect alterations, modifications and variations to the particular embodiments without departing from the intended scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A method for determining playback behavior in a media application for a wireless communications device having a memory with media files stored therein, the method comprising the steps of:
determining playback attributes associated with a media file;
determining if a user triggered event occurs during the media file playback;
determining if the media file playback ends due to the playback reaching the end of the media file;
selecting a function to perform based on playback attributes of the file being played and based on whether the playback ends or the user triggered event occurs, wherein the selected function is based upon the determined attributes associated with the media file; and
performing the selected function.

2. The method according to claim 1, wherein the user triggered event includes the user performing an action with the wireless communications device outside of the media application.

3. The method according to claim 1, wherein the user triggered event is selected from the group consisting of exiting the media application, minimizing the media application, and re-initiating playback of the same media file for which playback was previously terminated by the user.

4. The method according to claim 1, wherein the type of media file being played is selected from a group consisting of a video file, a music file, and a ring tone file.

5. The method according to claim 4, wherein the user triggered event is selected from the group consisting of exiting the media application and minimizing the media application and which performs the function selected from the group consisting of:
pausing the media file and saving to the memory a current position of the media file as a saved playback position;
stopping the media file and saving to the memory a current position of the media file as a saved playback position;
continuing to play the media file;
terminating playback of the media file including the displaying of a media menu to the user; and
automatically selecting and playing another media file.

6. The method according to claim 5, wherein the user triggered event includes re-initiating playback of the same media file previously played, the function selected from the group consisting of:
resuming playback of the media file from the saved playback position;
continuing to play the media file;
playing the media file from the beginning;
terminating playback of the media file including the displaying of a media menu to the user; and
automatically selecting and playing another media file.

7. The method according to claim 6, wherein the playback attributes are retrieved from metadata related to the type of media file being played, the metadata being stored within the media file.

8. The method according to claim 6, wherein the playback attributes related to the type of media file being played are metadata stored separately in the memory of the wireless communication device as media data.

9. The method according to claim 6, wherein the playback attributes are metadata based on the type of file extension associated with the media file.

10. A wireless device for determining media file playback behavior in a media application, the wireless device comprising:
a microprocessor for controlling the operation of the wireless device;
a first input device coupled to the microprocessor for accepting an input from a user of the wireless device;
a display device coupled to the microprocessor for communicating an output to the user;
a communications subsystem coupled to the microprocessor for communicating with a communications network; and
a memory coupled to the microprocessor,
the wireless device including a media application module resident in the memory for execution by the microprocessor, the memory having media files stored therein, the media application module being configured to:
determine media playback attributes associated with a media file;
determine if a user triggered event occurs during the media file playback;
determine if the media file playback ends due to the playback reaching the end of the media file;
select a function to perform based on the attributes of the media file being played and based on whether the playback ends or the user triggered event occurs, wherein the selected function is based upon the determined attributes associated with the media file; and
perform the selected function.

11. The wireless device according to claim 10, wherein the user triggered event includes the user performing an action with the wireless device outside of the media application module.

12. The wireless device according to claim 10, wherein the user triggered event is selected from the group consisting of exiting the media application module, minimizing the media application module, and re-initiating playback of the same media file for which playback was previously terminated by the user.

13. The wireless device according to claim 10, wherein the type of media file being played is selected from a group consisting of a video file, a music file, and a ring tone file.

14. The wireless device according to claim 13, wherein the media application module selecting the function to perform based on attributes of the media file being played and based on whether the playback ends or the user triggered event occurs is performed with the function selected from the group consisting of:
pausing the media file and saving to the memory a current position of the media file as a saved playback position;
stopping the media file and saving to the memory a current position of the media file as a saved playback position;
continuing to play the media file;
terminating playback of the media file including the displaying of a media menu to the user; and
automatically selecting and playing another media file.

15. The wireless device according to claim 14, wherein the user triggered event includes re-initiating playback of the same media file previously played, the functions selected from the group consisting of:
resuming playback of the media file from the saved playback position;
continuing to play the media file;
playing the media file from the beginning;
terminating playback of the media file including the displaying of a media menu to the user; and
automatically selecting and playing another media file.

16. The wireless device according to claim 10, wherein the media application module being configured to determine media playback attributes associated with the media file being played includes retrieving from the memory metadata related to the type of media file being played, the metadata being stored within the media file.

17. The wireless device according to claim 10, wherein the media application module being configured to determine media playback attributes of the file being played includes retrieving from the memory metadata related to the type of media file being played, the metadata being stored separately in the memory of the wireless device as media data.

18. The method according to claim 10, wherein the playback attributes are metadata based on the type of file extension associated with the media file.

19. A computer program product having a computer readable medium tangibly embodying code for determining playback behavior in a media application for a wireless communications device having a memory with media files stored therein, the computer program product including:
code for determining attributes associated with a media file;
code for determining if the media file playback ends due to the playback reaching the end of the media file;
code for determining if a user triggered event occurs during the media file playback;
code for selecting a function to perform based on the type of media file being played and based on whether the playback ends or the user triggered event occurs, wherein the selected function is based upon the determined attributes associated with the media file; and
code for performing the selected function.
